(19) United States
(12) Patent Application Publication
(10) Pub. No.: US 2025/0364661 A1
(43) Pub. Date: Nov. 27, 2025

(54) Consumer having an Electrical Interface and a Mechanical Interface for Connection to an Exchangeable Battery Pack

(71) Applicant: Robert Bosch GmbH, Stuttgart (DE)

(72) Inventors: Fabian Schempp, Stuttgart (DE); Tobias Fischer, Leinfelden-Echterdingen (DE)

(21) Appl. No.: 19/211,199

(22) Filed: May 18, 2025

(30) Foreign Application Priority Data
May 21, 2024 (DE) 10 2024 204 676.0

(51) Int. Cl. H01M 50/247; B25F 5/02; H01M 50/264

(52) U.S. Cl. CPC H01M 50/247; B25F 5/02; H01M 50/264; H01M 2220/30

(57) ABSTRACT

A consumer includes an electrical interface and a mechanical interface for connection to an exchangeable battery pack is disclosed. The electrical interface includes at least two contact elements. The mechanical interface includes at least one locking element receptacle. The consumer further includes an unlocking element that is movably arranged in the locking element receptacle.

This application claims priority under 35 U.S.C. § 119 to patent application no. DE 10 2024 204 676.0, filed on May 21, 2024 in Germany, the disclosure of which is incorporated herein by reference in its entirety.

### BACKGROUND

In DE 10 2018 210 679 A1, a battery pack with a locking element is described, wherein the battery pack comprises a control element for actuating the locking element.

### SUMMARY

The disclosure relates to a consumer having an electrical interface and a mechanical interface for connection to an exchangeable battery pack, wherein the electrical interface comprises at least two contact elements, wherein the mechanical interface comprises at least one locking element receptacle. It is proposed that the consumer have an unlocking element that is movably arranged in the locking element receptacle. Advantageously, the unlocking of the battery pack can thereby be optimized by the consumer.

The exchangeable battery pack is in particular part of a system consisting of the battery pack and a consumer, wherein the consumer is powered via the exchangeable battery pack during operation. The exchangeable battery pack is in particular configured as a hand-held power tool battery pack. The exchangeable battery pack is in particular designed to be connectable to a charging device for charging the exchangeable battery pack. Alternatively, the electrical consumer may also be configured as a way of transportation, for example an electric bicycle, as a domestic device, for example a vacuum cleaner, as a garden appliance, for example a hedge trimmer, or as a measuring device, wherein this list is not exhaustive.

The exchangeable battery pack comprises a housing, wherein the housing is preferably designed as an outer housing. At least one battery cell is received in the housing of the exchangeable battery pack. The exchangeable battery pack, in particular the housing of the exchangeable battery pack, can be detachably connected to the consumer and/or a charging device via a mechanical interface. The housing of the exchangeable battery pack may comprise one or more housing portions. The exchangeable battery pack may comprise a cell holder that is configured to receive and/or mount the battery cells in the housing. The cell holder may preferably comprise individual cell receptacles that are each configured to receive a single battery cell. Preferably, the cell holder is configured as one of the housing portions. The housing portions are connected to each other in a frictional, interlocking, and/or bonded manner. The cell holder is preferably made of a plastic, in particular a thermoplastic. The cell holder may partially form the outer housing of the exchangeable battery pack. The cell holder is preferably designed in an integral or one-piece design. In the context of the present application, the term “one-piece” is understood to mean a component that is designed to be made of one piece and not made of multiple components connected to one another in a bonded, and/or frictional, and/or interlocking manner. Accordingly, a one-piece component consists of a single material. In the context of the present application, the term “integral” is in particular understood to mean an integral components, or multiple components, connected to one another in a bonded manner, e.g. via 2K injection molding. Alternatively, it is also conceivable that the cell holder be designed in multiple parts, wherein the different parts are connected to each other in a frictional and/or interlocking manner.

The exchangeable battery pack has a mechanical interface corresponding to the mechanical interface of the consumer. The battery pack can be connected to the consumer in a frictional and/or interlocking manner via the mechanical interfaces. Advantageously, the mechanical interface of the exchangeable battery pack comprises at least one actuating element, via which the connection of the battery pack to the consumer and/or the charging device is detachable. The actuating element can, e.g., be designed as a button, a lever, or a pushbutton. In addition, the mechanical interface of the exchangeable battery pack includes in particular a locking element for locking the exchangeable battery pack with the consumer. The locking element is preferably mounted in a linearly and/or rotationally movable manner in the housing of the battery pack. The actuating element is preferably mechanically coupled to the actuating element, so that a movement of the actuating element can be directly transmitted to the locking element.

The exchangeable battery pack further comprises at least one electrical interface which corresponds to the electrical interface of the consumer and via which the exchangeable battery pack is electrically connectable to the consumer and/or the charging device. The exchangeable battery pack can, e.g., be charged and/or discharged via the electrical connection. Alternatively or additionally, it is also conceivable that information be communicable via the electrical interface. The electrical interface is preferably designed as a contact interface, where the electrical connection occurs via a physical contact of at least two conductive components. The electrical interface preferably comprises at least two electrical contact elements. In particular, one of the electrical contact elements is designed as a positive contact, and the other electrical contact element is designed as a negative contact. The electrical interface can further comprise at least one additional contact designed to transmit additional information to the consumer and/or the charging device. Alternatively or additionally, the electrical interface can comprise a secondary charging coil element for inductive charging. Furthermore, the at least one battery cell, which can be electrically connected to the consumer via the electrical contact device, is arranged in the housing of the exchangeable battery pack.

A battery cell can be designed as a galvanic cell which has a structure in which one cell pole comes to lie at one end and a further cell pole comes to lie at an opposite end. In particular, the energy storage cell has a positive cell pole on one end face and a negative cell pole on the opposite end face. Preferably, the battery cells are designed as NiCd or NiMh, particularly preferably as lithium-based battery cells or Li-ion battery cells. The battery voltage of the battery pack is typically a multiple of the voltage of a single battery cell and results from the circuit (parallel or serial) of the battery cells. In common battery cells with a cell voltage of 3.6 V, voltage classes of, by way of example, 3.6 V, 7.2 V, 10, 8 V, 14.4 V, 18 V, 36 V, 54 V, 108 V, etc., are therefore produced. A battery cell is preferably designed as an at least substantially cylindrical round cell, wherein the cell poles are arranged at the ends of the cylindrical shape. The electrical interface of the consumer preferably comprises a contact carrier on which the at least two electrical contact elements are arranged. The contact carrier is preferably made of a plastic, in particular a hard plastic.

The mechanical interface of the consumer preferably comprises at least one guide element for guiding the exchangeable battery pack during the connection process. By way of example, the mechanical interface may comprise two guide elements in the form of guide rails or guide grooves.

The locking element receptacle of the mechanical interface of the consumer is configured to receive the locking element of the exchangeable battery pack. The locking element receptacle is preferably shaped such that at least one wall of the locking element receptacle in the locked state forms a stop opposite the connection direction.

The unlocking element of the mechanical interface of the consumer is movably mounted in a housing of the consumer. The unlocking element may be linearly and/or rotatably movable. The unlocking element may engage with the locking element receptacle in the locked state and/or the unlocked state, and may preferably form a stop for the locking element of the exchangeable battery pack.

Furthermore, it is proposed that the consumer have an actuating element for actuation by a user, wherein the actuating element is mechanically coupled to the unlocking element. The actuating element may exemplary comprise a pushbutton, a button, a switch, etc. The actuating element may be arranged in close proximity to or spaced apart from the mechanical interface.

Furthermore, it is proposed that the actuating element is coupled to the unlocking element such that a movement of the actuating element in a first direction is converted to a movement of the unlocking element in a second direction. Advantageously, a particularly ergonomic design of the mechanical interface can be realized as a result. The first direction and the second direction may be formed intersecting or oppositely. Likewise, it is conceivable that the first direction takes place along a linear movement and the second direction along a rotational movement, or vice versa. It is also conceivable to use a slotted guide.

In addition, it is proposed that the actuating element is mounted linearly movably in a housing of the consumer and the unlocking element is mounted in a rotationally movable manner in the housing of the consumer. Advantageously, a particularly compact design of the mechanical interface can be realized as a result.

Furthermore, it is proposed that the unlocking element is configured to be actuatable for locking the exchangeable battery pack. As a result, the connection process can be optimized in an advantageous manner.

It is further proposed that the consumer comprises a removal aid configured to remove the exchangeable battery pack, wherein the removal aid is movably mounted in the housing of the consumer. In particular, the removal aid is connected to the actuating element. As a result, the removal process can be simplified in an advantageous manner. The removal aid may comprise one or more removal elements that directly impinge on the exchangeable battery pack to aid removal.

It is also proposed that a guide for the removal aid is arranged between the electrical contact element. This allows a particularly compact design to be achieved.

Furthermore, it is proposed that the actuating element comprises a handle.

### BRIEF DESCRIPTION OF THE DRAWINGS

Further advantages follow from the description of the drawings below. The drawings, the description, and the claims contain numerous features in combination. A person skilled in the art will appropriately also consider the features individually and combine them into additional advantageous combinations.

The figures show:

FIG. 1 a schematic side view of a consumer with an exchangeable battery pack;

FIG. 2 a perspective view of the exchangeable battery pack of FIG. 1;

FIG. 3 a partial perspective view of a mechanical interface of the consumer;

FIG. 4 a further perspective view of the mechanical interface of FIG. 3;

FIG. 5 a side section of the mechanical interface according to FIG. 3.

### DETAILED DESCRIPTION

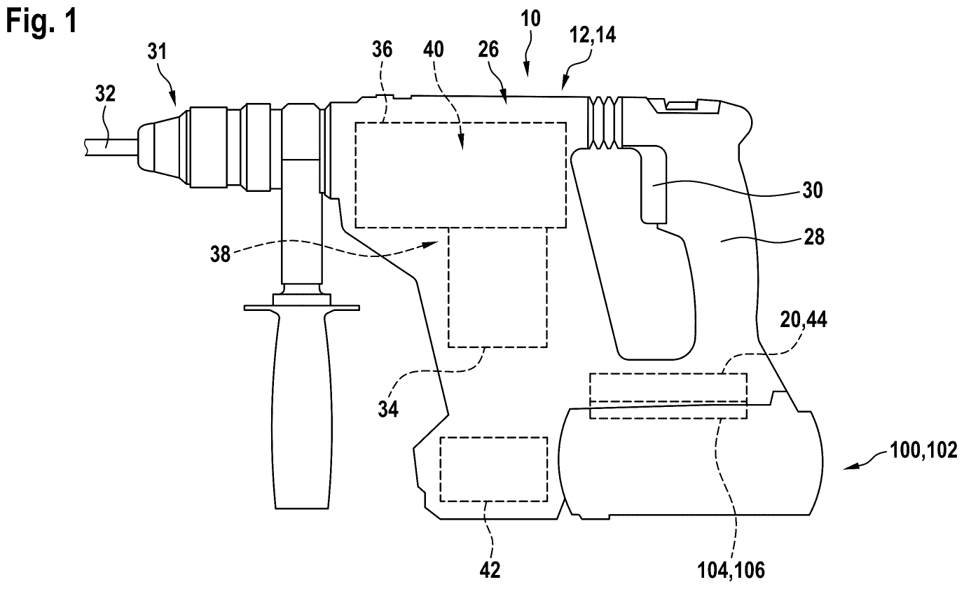

In FIG. 1, a side view of a system 10 consisting of an example electrical consumer 14 configured as a hand-held power tool 12 and an exchangeable battery pack 100 are shown as an example in the form of a hand-held power tool battery pack 102. The hand-held power tool 12 is thus configured as a cordless hand-held power tool and is powered in operation via the exchangeable battery pack 100. The hand-held power tool 12 and the exchangeable battery pack 100 each have a mechanical interface 20, 104 via which the two components of the system 10 are detachably connected to each other. The exchangeable battery pack 100 is thus detachable or interchangeable and can be replaced by the same or similar exchangeable battery pack. The hand-held power tool 12 is configured as a drill hammer. The mechanical interface 20 of the exchangeable battery pack 100 is also configured to be detachably connectable to a charging device that is not shown.

The hand-held power tool 12 comprises a housing 26, at the rear end of which a handle 28 is arranged with an operation switch 30 for switching the hand-held power tool 12 on and off. A tool receptacle 31 is arranged at the front end of the housing 26 of the hand-held power tool 12 and is provided for receiving an insertion tool 32. A drive unit 38 comprising an electric motor 34 and a gearbox 36 is arranged between the handle 28 and the tool holder 31. The gearbox 36 comprises a percussion unit 40 and is arranged above the electric motor 34. The percussion unit 40 comprises a pneumatic percussion mechanism. Below the electric motor 34, an electronic unit 42 is arranged, via which the hand-held power tool 12 can be regulated or controlled. The exchangeable battery pack 100 is arranged below the handle 28 and adjacent to the electronic unit 42.

The exchangeable battery pack 100 and the consumer 14 each have a corresponding electrical interface 44, 106 via which the exchangeable battery pack 100 is electrically connectable to the consumer 14, in particular the electronic unit 42 of the consumer 14. When connected to each other, the exchangeable battery pack 100 provides the power supply for the consumer 14.

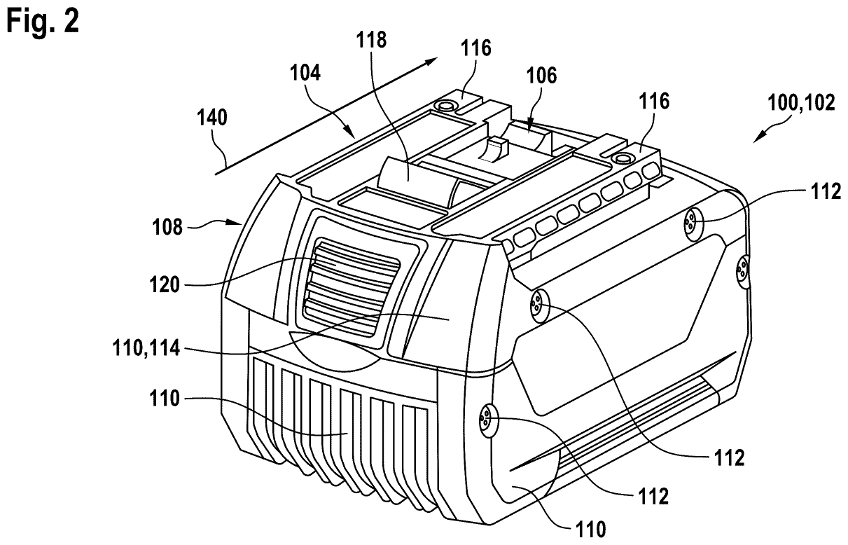

The exchangeable battery pack 100 is shown in FIG. 2 in a perspective view. The exchangeable battery pack 100 comprises a housing 108. The housing 108 of the exchangeable battery pack 100 is exemplary made of a plastic, in particular a hard plastic. The housing 108 of the exchangeable battery pack 100 comprises a plurality of housing portions 110 connected to each other in the form of screws, by way of connecting mechanism 112, as an example.

The upper housing portion 110 is formed as an interface housing portion 114 and comprises the electrical interface 106 and the mechanical interface 104 of the exchangeable battery pack 100. The interface housing portion 114 is largely obstructed by the hand-held power tool 12 when connected to the hand-held power tool 12. The mechanical interface 104 comprises, by way of example, two guide elements 116 in the form of guide rails configured to guide in corresponding guide elements of the electrical consumer 14 during the connection process. The connection process occurs along a connection direction 140. The connection direction 140 is configured linearly as an example and extends straight along the guide element 116.

In addition, the exchangeable battery pack 100 comprises a lock having a locking element 118. The locking element 118 is exemplary configured as a movable, in particular rotatable, locking element 118 and biased with a spring element (not shown) towards the locking position. The lock also includes an actuating element 120 that is configured to be manually actuatable. The actuating element 120 is also mounted, by way of example, in the housing 108 of the exchangeable battery pack 100, in particular in the interface housing portion 114, in a linearly movable manner as an example.

The exchangeable battery pack 100 has, by way of example, ten battery cells (not shown) arranged in the housing 108 of the exchangeable battery pack 100. An electronic unit (not shown) is also arranged in the housing 108 of the exchangeable battery pack 100. The electronic unit comprises, by way of example, a printed circuit board on which electrical components, such as light emitting diodes, power semiconductors, switches, temperature sensors, a computing unit, a storage unit, etc., are arranged.

The actuating element 120 is linearly movable in the housing 108 of the exchangeable battery pack 100 and may be actuated by actuating along the connection direction 140 to unlock. The locking element 118 is coupled to the actuating element 120 such that the locking element 118 pivots into the housing 108 of the exchangeable battery pack 100.

As the actuating element 120 must be actuated in the opposite direction to the release direction, which is opposite to the connection direction 140, the geometry of the consumer 14 or contamination that occurs during operation of the consumer 14 can lead to jamming of the exchangeable battery pack 100, which makes it considerably more difficult to release the exchangeable battery pack 100 using the actuating element 120.

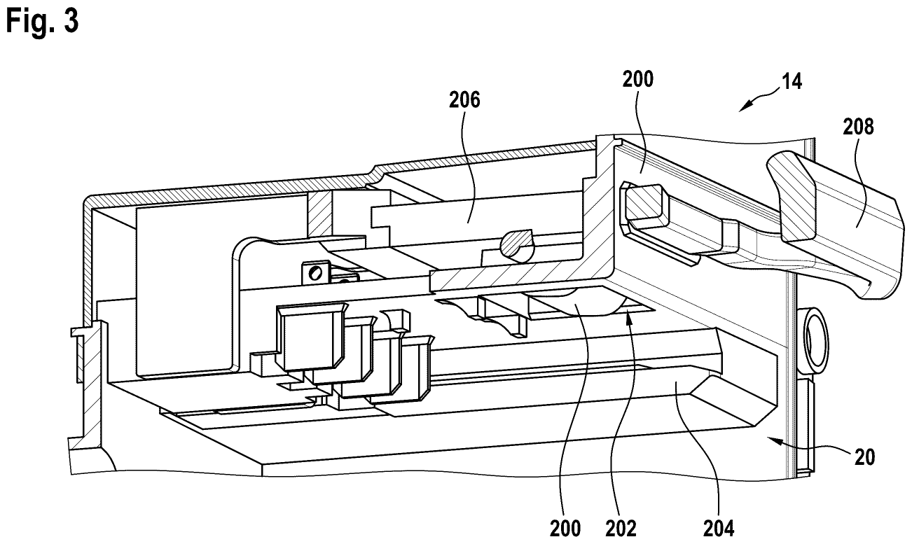

The consumer 14 comprises an unlocking element 200 configured to unlock the exchangeable battery pack 100 and shown in a partial perspective view in FIG. 3. The unlocking element 200 is movably, by way of example, rotatably movably, arranged within the housing 26 of the consumer 14. In particular, the unlocking element 200 is arranged in a locking element receptacle 202 of the consumer 14, in particular the mechanical interface 20 of the consumer 14. The locking element receptacle 202 is configured to receive the locking element 118 of the exchangeable battery pack 100 in the locked state. In the locked state, the locking element receptacle 202 and/or the unlocking element 200 of the consumer 14 forms a stop against the connection direction 140 of the exchangeable battery pack 100, so that the exchangeable battery pack 100 cannot be detached without actuation.

The locking element receptacle 202 is arranged, by way of example, between two guide rails 204 corresponding to guide grooves of the exchangeable battery pack 100.

The mechanical interface 20 of the consumer 14 further comprises an actuating element 206 for actuation by a user, wherein the actuating element 206 is mechanically coupled to the unlocking element 200. The actuating element 206 can be, by way of example, directly actuated by the user, but it would also be contemplated that indirect actuation could be performed by further components or by an electric actuator.

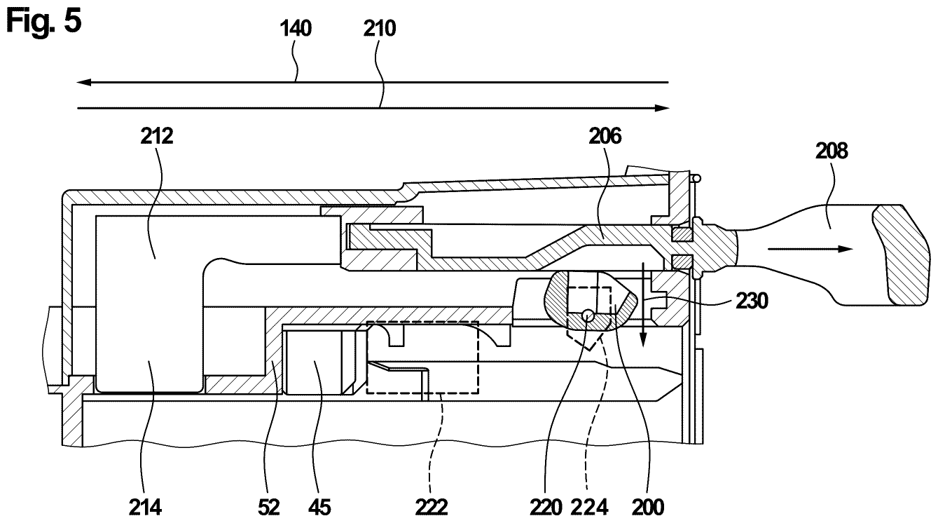

The actuating element 206 is movably configured and, by way of example, mounted linearly in the housing 26 of the consumer 14. The actuating element 206 of the consumer 14 is configured to come into direct contact with the unlocking element 200 in at least one state and thus abut the unlocking element 200. The actuating element 206 is preferably connected to a resetting element not shown, by way of example in the form of a spring. Preferably, the resetting element is configured to apply a force to the actuation element towards the unactuated state such that the actuating element 206 is actuated only when there is a direct force. Alternatively or additionally, it is also conceivable that a resetting element is provided, which affects another component, for example the unlocking element 200, in particular directly. By way of example, the actuating element 206 comprises a handle 208 configured to allow a user to actuate the actuating element 206 by pulling. However, a different type of actuation would also be conceivable, for example pushing a button or a switch. The handle 208 is preferably arranged entirely outside of the housing 26 of the consumer 14. However, it would also be conceivable to partially or completely arrange the handle 208 within the outer contour of the housing 26. The actuating element 206 is configured as an example in such a way that an actuating direction 210 (see FIG. 5) of the actuating element 206 takes place opposite the connection direction 140 of the exchangeable battery pack 100.

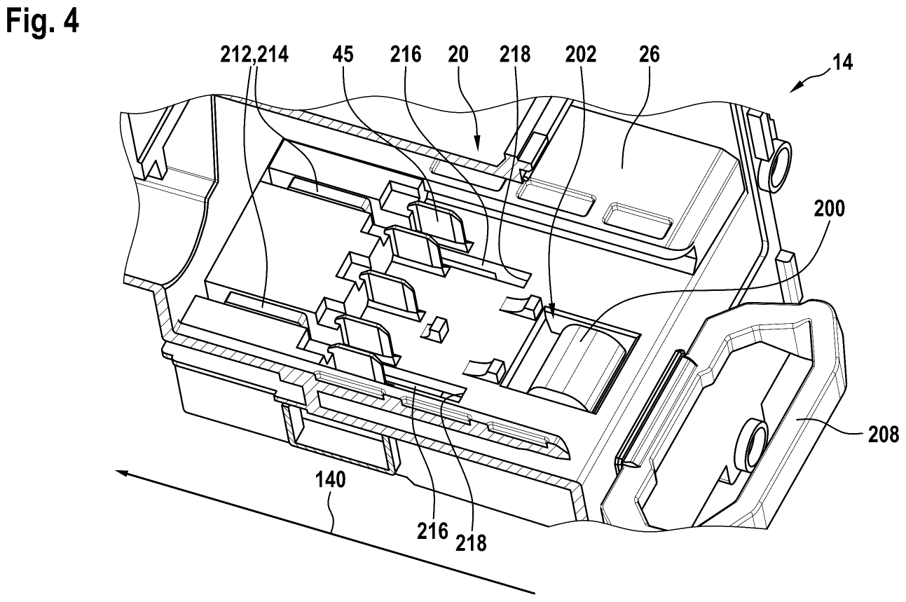

In FIG. 4, the mechanical interface 20 of the consumer 14 is shown in a further perspective view. The mechanical interface 20 has a removal aid 212 in addition to the unlocking element 200, which is configured to assist with the removal of the exchangeable battery pack 100.

The removal aid 212 is movably, by way of example linearly movably, mounted in the housing 26 of the consumer 14. The mechanical interface 20 of the consumer 14 is shown in an unactuated state in FIG. 4. Along the connection direction 140 of the exchangeable battery pack 100, first the handle 208 of the actuating element 206, then the locking element receptacle 202 is arranged with the unlocking element 200, then the five electrical contact elements 45 of the electrical interface 44 of the consumer 14, and then the removal aid 212.

The removal aid 212 comprises two removal elements 214, by way of example. The removal elements 214 are exemplary fin-shaped and arranged in an elongate guide recess 216 in the housing 26 of the consumer 14. The elongate guide recess 216 extends, by way of example, substantially along the connection direction 140 and in a straight line. By way of example, the elongate guide recess 216 begins in front of the electrical contact elements 45 of the consumer 14 and ends behind the electrical contact elements 45 of the consumer facing toward the connection direction 140. In particular, the guide recesses 216 are configured such that the removal elements 214 are substantially arranged in the housing 26 of the consumer 14 in the unactuated state and exit the housing 26 of the consumer in the actuated state. The removal aid 212, in particular the removal elements 214, is connected to the actuating element 206 such that the removal elements 214 are movable via actuation of the actuating element 206. By way of example, the removal elements 214 are connected to the actuating element 206 in a one-piece design, such that the removal elements 214 perform the same movement as the actuating element 206. However, an integral or multi-part configuration of the removal elements would also be conceivable.

In particular, the elongate guide recess 216 is configured such that the removal elements 214 are movable from a position behind the electrical contact elements 45 of the consumer 14 to a position in front of the electrical contact elements 45 of the consumer 14 by actuating the actuating element 206. Movement is thereby limited via stops 218.

In FIG. 5, the mechanical interface 20 of the consumer 14 is shown in a side view and in an unactuated state.

In this state, the exchangeable battery pack 100 can be connected to the consumer 14, wherein the exchangeable battery pack 100 is connected in the connected state in an interlocking manner to the consumer 14. In particular, the electrical contact elements of the exchangeable battery pack 100, which are configured as an example in the form of spring contacts, in particular tulip contacts, are connected to the electrical contact elements 45 of the consumer 14, such that the housing 108 of the exchangeable battery pack 100 extends at least to the electrical contact elements 45 of the consumer 14, in particular to a stop 52 in the connection direction 140 behind the electrical contact elements 45.

The removal element 214 of the removal aid 212 is arranged behind the stop 52 in the connection direction 140 and thus also spaced apart from the housing 108 of the exchangeable battery pack 100.

In the unactuated state, the unlocking element 200 is also not actuated and arranged to apply no force or insufficient force on the locking element 118 of the exchangeable battery pack 100 for actuation. By way of example, the actuating element 206 of the consumer 14 is configured spaced apart from the unlocking element 200.

By actuating the actuating element 206 by pulling on the handle 208, the actuating element 206 is moved linearly with the removal aid 212 in the actuation direction 210 opposite to the connection direction 140.

The actuating element 206 is shaped such that the linear movement of the actuating element 206 applies a force on the unlocking element 200 and performs rotational movement about an axis of rotation 220. This moves the unlocking element 200 in a second direction 230 that differs from the actuation direction 210 and, by way of example, extends substantially perpendicular to the latter. The unlocking element 200 is formed such that the rotational movement causes the unlocking element 200 to reach into the space where the exchangeable battery pack 100, in particular the locking element 118 of the exchangeable battery pack 100, extends and apply a force to the locking element 118 and actuate it in such a way that the lock is released.

The actuating element 206 is formed such that the locking element 118 of the exchangeable battery pack 100 remains actuated even with increasing movement along the actuation direction 210 and the removal elements 214 are guided past the stop 52 of the consumer and past the electrical contact elements 45 of the consumer 14 in the actuation direction 210. In particular, the housing 108 of the exchangeable battery pack 100 in the unlocked state is thereby acted upon by the removal elements 214 with a force counter to the connection direction 140 and thus the exchangeable battery pack 100 is released without actuation of the actuating element 120 of the exchangeable battery pack 100 and at least partially released from the consumer 14. Subsequently, the exchangeable battery pack 100 can be grasped and removed from the consumer 14.

A position 222 of the removal element 214 in the actuated state and a position 224 of the unlocking element 200 in the actuated state are shown as dashed lines.

Furthermore, it remains possible to release the lock independently of the unlocking element 200 by actuating the actuating element 120 of the exchangeable battery pack 100 and to disconnect the exchangeable battery pack 100 from the consumer 14. Thus, the lock may be released via both the actuating element 200 of the exchangeable battery pack 14 and the actuating element 206 of the consumer 14.

What is claimed is:

1. A consumer, comprising:
an electrical interface;
a mechanical interface configured to be connected to an exchangeable battery pack; and
an unlocking element,
wherein the electrical interface includes at least two contact elements,
wherein the mechanical interface includes at least one locking element receptacle, and
wherein the unlocking element is movably arranged in the at least one locking element receptacle.

2. The consumer according to claim 1, further comprising an actuating element configured to be actuated by a user, wherein the actuating element is mechanically coupled to the unlocking element.

3. The consumer according to claim 2, wherein the actuating element is coupled to the unlocking element such that a movement of the actuating element in a first direction is converted to a movement of the unlocking element in a second direction.

4. The consumer according to claim 2, further comprising a housing, wherein:
the actuating element is mounted linearly movably in the housing, and
the unlocking element is mounted in a rotationally moveable manner in the housing.

5. The consumer according to claim 1, wherein the unlocking element is configured to be operable for locking the exchangeable battery pack.

6. The consumer according to claim 4, further comprising at least one removal aid configured to remove the exchangeable battery pack, wherein the at least one removal aid is movably mounted in the housing.

7. The consumer according to claim 6, characterized in that the at least one removal aid is connected to the actuating element.

8. The consumer according to claim 6, wherein the housing comprises a guide recess for the at least one removal aid that is arranged between the at least two contact elements.

9. The consumer according to claim 6, wherein the at least one removal aid is configured to be partially or completely removed from the housing by actuating the actuating element.

10. The consumer according to claim 2, wherein the actuating element comprises a handle.
